(19) United States
(12) Patent Application Publication
(10) Pub. No.: US 2001/0041572 A1
(43) Pub. Date: Nov. 15, 2001

(54) Telecommunications network

(76) Inventors: Anders Lundqvist, Spanga (SE); Lars B. Johansson, Linkoping (SE); Lars Johansson, Linkoping (SE)

Correspondence Address: BURNS DOANE SWECKER & MATHIS L L P, POST OFFICE BOX 1404, ALEXANDRIA, VA, 22313-1404, US

(21) Appl. No.: 09/736,323

(22) Filed: Dec. 15, 2000

(30) Foreign Application Priority Data
Dec. 16, 1999 (GB) 9929774.9

(51) Int. Cl. H04Q 7/20

(52) U.S. Cl. 455/450; 455/444; 455/446; 455/509; 455/513

(57) ABSTRACT

There is described a cellular communications network using macrodiversity, for example a CDMA network, and a method of operation thereof, which allow a network operator to influence movements of a mobile station within the radio environment.

Cells are considered in groups. When a handover is contemplated, the system takes into account the groups which include the cells to which radio links are already established and the group which includes the cell to which the establishment of a new radio link is contemplated.

A candidate cell, which is in a different group from all existing cells to which radio links are already established, must meet a higher quality threshold than if it is in a group to which a radio link is already established, before a link to it is established.

### TECHNICAL FIELD OF THE INVENTION

This invention relates to a mobile telecommunications network, and more specifically to a CDMA cellular network, or other cellular network using macrodiversity, in which mobile terminals can be handed over from one cell to another.

### BACKGROUND OF THE INVENTION

In cellular telecommunications systems, there is conventionally a mechanism to allow a mobile terminal to be handed over, from communicating with a base station in one cell, to another base station in another cell.

The GSM system (Global system for Mobile Communication) is a TDMA (Time Division Multiple Access) system. That is, each available frequency is divided into time slots, and each time slot is a channel, to which a mobile terminal can be allocated. In GSM, a mobile terminal is handed over from one cell to another when certain conditions are met. For example, a handover may take place depending on signal strength measurements, made in the mobile terminal, for signals received from several base stations. Thus, each cell has a set of thresholds associated with handovers to that cell from each neighbouring cell. When the relevant threshold is reached, a mobile terminal in the relevant neighbouring cell will be handed over. Since the threshold levels can be set by the network operator, this gives flexibility in causing some handovers in preference to others.

For example, hierarchical cell structures can be used, in which macro cells might cover relatively large areas, micro cells might cover smaller areas where users are concentrated, and pico cells might cover even smaller areas, such as single buildings, which have particularly high concentrations of users.

Each neighbouring cell is then allocated a different set of frequencies, and a mobile terminal can be directed to use a specific channel. In such a situation, it is undesirable for a mobile terminal in a moving vehicle communicating with a macro cell to be handed over to a pico cell associated with a specific building, even if that pico cell is momentarily giving the strongest signal. To prevent users being allocated to inappropriate cells, thresholds for handovers can be set which, for example, make handovers from macro cells to pico cells less likely.

For example, WO98/53652 describes a system in which there may be a neighbourhood zone, which may for example cover a single building including several cells. All cells within the neighbourhood zone share the same list of neighbouring cells, which means that all base stations in the neighbourhood zone instruct associated mobile stations to monitor and measure the same list of measurement channels.

CDMA (Code Division Multiple Access) systems also exist. These share some of the features of TDMA systems such as GSM, but have important differences.

In a CDMA system, it is difficult to have hierarchical cell structures, because the same frequency band is typically used for all cells, and the power regulation in effect requires that neighbouring cells have a similar size.

Further, CDMA systems typically use macro-diversity. This means that at any given time, a mobile terminal may have radio links to more than one cell.

Further, CDMA systems typically do not set different handover thresholds, for handovers into a particular cell, depending on the cell in which the mobile is at present located.

### SUMMARY OF THE INVENTION

CDMA systems consider handovers in a way which is rather different from TDMA systems. In a macro diversity CDMA system, the definition of a handover is when a new connection is set up between a MS and a base station site. When a new connection is set up, an old connection is not automatically released, and conversely if a connection is released for some reason, a new connection is not necessarily automatically set up.

Further, different sorts of handover are possible in a network using macro-diversity. For example, a mobile terminal may establish a new radio link with a base station with which one radio link is already established. Alternatively, a mobile terminal may establish a new radio link with a new base station, controlled by a radio network controller which controls a base station with which a radio link is already established. Further, alternatively, a mobile terminal may establish a new radio link with a new base station, controlled by a different radio network controller from that which controls a base station with which a radio link is already established.

These different sorts of handover have different costs associated therewith for the network operator. It is therefore desirable for the network operator to have a way of controlling which handovers are carried out.

The present invention is concerned with a method, and a network, in which-calls are considered in groups. When a handover is contemplated, the system takes into account the groups which include the cells to which radio links are already established and the group which includes the cell to which the establishment of a new radio link is contemplated.

A candidate cell must meet a quality criterion before a new radio link is established thereto. The quality criterion which is applied is more difficult to meet in the case of a candidate cell which is in a different group from all existing cells to which radio links are already established, than in the case of a candidate cell which is in the same group as a cell to which a radio link is already established.

This allows the network operator some flexibility in discouraging handovers which involve higher costs.

### BRIEF DESCRIPTION OF DRAWINGS

FIG. 1 shows a first network in accordance with a simplified embodiment of the invention.

FIG. 2 shows a second network in accordance with the invention.

FIG. 3 shows a third network in accordance with the invention.

### DETAILED DESCRIPTION OF PREFERRED EMBODIMENTS

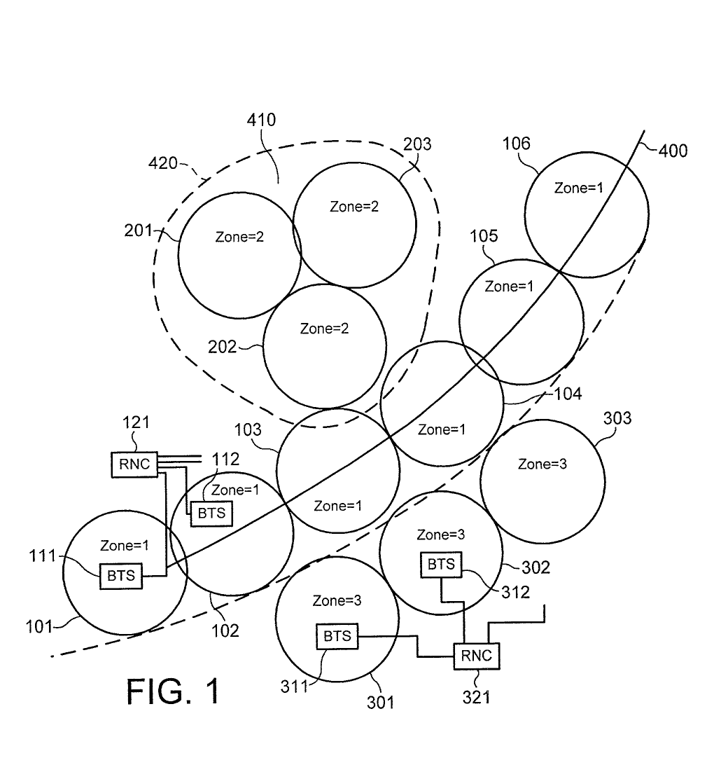

FIG. 1 is a schematic illustration of a Code Division Multiple Access (CDMA) radio telecommunications network in accordance with the invention. As is conventional, the area served by the network is divided into cells 101, 102, 103, 104, 105, 106, 201, 202, 203, 301, 302, 303, only some of which are shown in FIG. 1. Each cell includes a base station (BTS) 111, 112, 311, 312, of which again only some are shown in FIG. 1. Each base station is controlled by a respective radio network controller (RNC) 121, 321, of which again only a small number are shown in FIG. 1.

In the area represented by FIG. 1, a highway 400 runs close to a town 410.

In accordance with the invention, cells 101, 102, 103, 104, 105, 106 along the highway 400 are considered to be in a particular zone, referred to as Zone 1, cells 201, 202, 203 serving the town 410 are considered to be in a different zone, referred to as Zone 2, and cells 301, 302, 303, which are controlled by a different RNC from the other cells shown in FIG. 1, are considered to be in a further different zone, referred to as Zone 3. Dashed line 420 represents the border around Zone 2, while dashed line 430 represents the border between Zones 1 and 3.

The zones may be defined by the network operator using any desired criteria. The zones are also referred to herein as groups. Although it may be desirable for groups of cells to be in geographically distinct zones, as illustrated in FIG. 1, this is not necessary.

In a CDMA system, there are three types of soft/softer handover.

In a softer handover, a new radio link is added between a mobile station and a base station to which that mobile station already has a radio link. The only additional resource required for this new radio link is a channelisation code.

In the case of an intra-RNC soft handover, a new radio link is added between a mobile station and a base station which has no radio link to that mobile station. This requires a channelisation code for the new link, and also uses hardware and software in the new base station, and requires a transmission link between the new base station and the RNC, and an entry in the diversity handover (DHO) unit in the RNC.

In the case of an inter-RNC soft handover, a new radio link is added between a mobile station and a base station which not only has no radio link to that mobile station, but is controlled by a different RNC from the base station (or base stations) which has (or have) such links. This again requires a channelisation code for the new link, and uses hardware and software in the new base station, and requires a transmission link between the new base station and the new RNC, hardware and software in the new RNC, a transmission link between the old RNC and the new RNC, and sometimes an entry in the diversity handover (DHO) unit in the old RNC.

It can thus be seen that the different types of handover require very different levels of resources.

A mobile station typically has simultaneous connections (radio links) to a number of cells. These cells are called the “active set”. Typically, an active set can contain a maximum of four cells.

Conventionally, an active mobile station makes measurements on other cells. Each cell not in the active set is compared with the best cell in the active set and, if it is better than a threshold level set a first predetermined amount below the best cell, it is added to the active set. If the active set already contains the maximum number of cells, the new cell is compared with the worst cell in the active set, and replaces the worst cell only if it is better than a threshold level set a second predetermined amount above the worst cell. A cell can be removed from the active set at any time if it is worse than a threshold level set a third predetermined amount below the best cell.

The present invention provides a way of preventing or discouraging handovers which are of relatively high cost, by effectively adjusting the values of these first, second and third thresholds. This is illustrated first with reference to FIG. 1.

In FIG. 1, as mentioned above, the cells are defined as being in different groups or zones. Each zone has a cost value associated therewith for the purposes of determining which new radio links should be established. This cost value means that a new radio link will be established only when any such cost associated therewith is exceeded by the benefit of establishing the link. The cost can be that a higher signal quality threshold must be reached, or that a particular signal quality threshold must be maintained for a longer time.

An alternative is that each cell could have a cost value associated therewith, allowing different cost values for different cells within a group.

Once a mobile station has established a radio link with one base station in a group, no further cost is associated with the establishment of radio links with other base stations in the same group.

Zone 2 in the FIG. 1 example is preferably reserved for mobile stations within the town 410. Meanwhile, cells in zone 3 are controlled by a different RNC from cells in zones 1 and 2. Thus, it is generally preferable for a user travelling on the highway 400 to establish links only with cells in zone

This is achieved in that, when the user is travelling on the highway, with links established with cells in zone 1, the existence of the costs associated with the other zones means that new radio links will be established with cells in zone 2 or zone 3 only if such radio links become good enough to overcome the penalty associated with the establishment of a link with a new handover zone. Under normal conditions, travelling on the highway 400, the user will therefore only establish links with cells in zone 1.

However, if the mobile station user leaves the highway 400 and enters the town 410, it will probably be desirable for him to use the cells which cover the town. In this situation, the way the invention works is that, at first, all links are established with cells in zone 1. The existence of the costs associated with the other zones means that a new radio link will be established with a cell in zone 2 only if such a cell meets a relatively high required threshold. This provides a way of ensuring that radio links are normally established with cells covering the town 410 by mobile stations actually located within the town.

However, as soon as the mobile station establishes a new radio link with one cell in zone 2, it belongs to both zone 1 and zone 2, and no additional cost is associated with any other cell in zone 1 or in zone 2. For a mobile station within the town 410, this will normally mean that thereafter new radio-links will rapidly be established with cells in zone 2. When the last radio link to a cell in zone 1 has been removed, and the mobile station only has links to cells in zone 2, it belongs only to cells in zone 2. The existence of the costs associated with the other zones then means that a new radio link will be established with a cell in zone 1, for example, only if such a cell meets a relatively high required threshold. Of course, this happens only if the link with the cell in zone 1 becomes good enough to overcome the penalty associated with the establishment of a link with a new handover zone.

The costs associated with the zones can differ, making it easier for a mobile station belonging to zone 1 to establish links-with cells in zone 2 than for a mobile station belonging to zone 2 to establish links with cells in zone 1, or vice versa, if desired. Moreover, the costs can be varied by the network operator at different times etc.

The invention can also be illustrated with reference to a user travelling on the highway 400 who crosses the border 430, into an area covered by cells controlled by the RNC 321. In this situation, the way the invention works is that, at first, all links are established with cells in zone 1. The existence of the costs associated-with the other zones means that a new radio link will be established with a cell in zone 3 only if such a cell meets a relatively high required threshold.

However, as soon as the mobile station establishes a new radio link with one cell in zone 3, it belongs to both zone 1 and zone 3, and no additional cost is associated with any other cell in zone 1 or in zone 3. For a mobile station now travelling in zone 3, this will normally mean that thereafter new radio links will rapidly be established with cells in zone 3. When the last radio link to a cell in zone 1 has been removed, and the mobile station only has links to cells in zone 3, it belongs only to cells in zone 3. The existence of the costs associated with the other zones then means that a new radio link will be established with a cell in zone 1, for example, only if such a cell meets a relatively high required threshold. Of course, this happens only if the link with the cell in zone 1 becomes good enough to overcome the penalty associated with the establishment of a link with a new handover zone.

The effect of this is that, for most of the time, the mobile station will belong only to one zone or another, and thus only one RNC will need to be involved in the control thereof. Compared with a conventional situation, there is only a relatively short time period in which the mobile station is controlled by two RNCs which, as discussed earlier, is relatively expensive for the network in terms of resources employed.

However, although the tendency of the system is to maintain a user in only one zone, this can be overridden. For example, when the user is travelling on the highway, with links established with cells in zone 1, he may encounter poor radio conditions. In such a situation, radio links with cells in zone 2 or zone 3 might be evaluated as in some way considerably better than radio links which could be established with cells in zone 1. Depending on the relative quality of such alternative links, and the relative costs associated with the other zones, links can be established with cells in zone 2 and/or cells in zone 3.

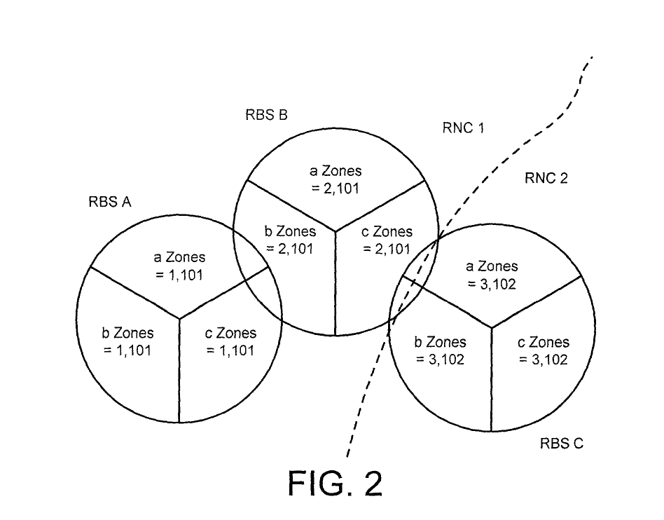

FIG. 2 shows a representative part of an example of a network with costs associated with establishing a new link not just at one level, but at two.

Thus, the illustrated part of the network includes three base stations RBS-A, RBS-B and RBS-C, which provide coverage to respective cells. Base stations RBS-A and RBS-B are handled by one radio network controller RNC1, while base station RBS-C is handled by another radio network controller RNC2. Each base station handles communications with three cells, a, b and c respectively. A mobile can establish a separate link with each cell A.a, A.b, A.c, B.a, etc.

In this example, there is one handover zone associated with each base station, and one handover zone associated with each radio network controller. The zones, to which each sector belongs, are shown on FIG. 1. Thus cell A.a belongs to handover zones 1,101, zone 1 being associated with base station RBS-A and zone 101 being associated with radio network controller RNC1. Similarly, cell C.b belongs to handover zones 3,102, zone 3 being associated with base station RBS-C and zone 102 being associated with radio network controller RNC2.

Thus, if for example the active set at one moment consists of cell A.a only, there is no penalty associated with cells A.b or A.c, since they both belong to the same handover zones as cell A.a. Thus, radio links to those cells can be added if they meet the usual thresholds.

However, adding cell B.b would mean introducing handover zone 2, and a radio link to this cell is added only if the required threshold is met even after application of the penalty associated with handover zone 2.

Further, if for example the active set at one moment consists of cell B.c only, adding cell C.a would mean introducing two new handover-zones, handover zone 3 associated with base station RBS-C, and handover zone 102 associated with radio network controller RNC2. As a result, a radio link to this cell is added only if the required threshold is met even after application of the penalties associated with these two handover zones.

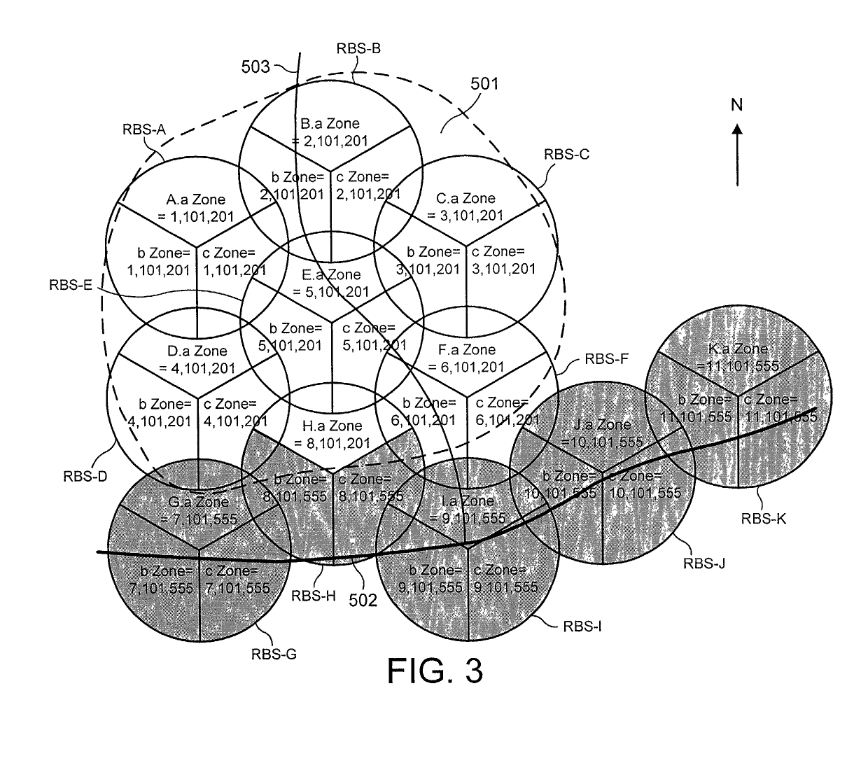

FIG. 3 shows a representative part of an example of a network with costs associated with establishing a new link at three levels.

Thus, the illustrated part of the network includes eleven base stations RBS-A, RBS-B, RBS-C, . . . , RBS-J, RBS-K, which provide coverage to respective cells. All eleven base stations are handled by one radio network controller RNC1, so in this example there is no need to establish a radio link with any new controller, but it will be appreciated that the cells may be controlled by different radio network controllers, and that handover zones may be defined which coincide with the extent of the cells controlled by one RNC.

As in FIG. 2, each base station handles communications with three cells, a, b and c respectively. A mobile can establish a separate link with each cell A.a, A.b, A.c, B.a, etc.

In this example, there is one handover zone associated with each base station, and one handover zone associated with the single radio network controller. Moreover, additional handover zones are defined to further manage the allocation of network resources. Specifically, the area under consideration includes an urban area 501, a major highway 502, and a minor road 503 running from the highway through the urban area.

In general, it is preferable if radio network users in fast moving vehicles on the highway 502 can be restricted to establishing radio links with the shaded cells, thereby “protecting” the unshaded cells, unless establishment of a link with an unshaded cell is really required.

Thus, the shaded cells belong to one handover zone 555, while the unshaded cells belong to a different handover zone 201.

The zones, to which each cell belongs, are shown on FIG. 3. Thus cell A.a belongs to handover zones 1, 101, 201, zone 1 being associated with base station RBS-A, zone 101 being associated with the radio network controller, and zone 201 being associated with the unshaded cells covering the urban area 501. Similarly, sector J.b belongs to handover zones 10, 101, 555, zone 10 being associated with base station RBS-J, zone 101 being associated with the radio network controller, and zone 555 being associated with the shaded cells covering the highway 502.

In the case of a network user travelling on the highway 502, and about to leave the highway to travel on the road 503, he will probably have cells I.a and I.b in the active set, and may for example have cells H.c and J.b also in the active set. When first travelling on the minor road 503, the link with the cell I.b will probably become noticeably worse than that with the cell I.a, and will then be removed from the active set. By contrast, as the mobile user travels into cell F.b, the link with that cell will become better. However, establishment of a connection with cell F.b will only occur when that link becomes good enough to overcome the penalty associated with the establishment of links with two new handover zones, namely zones 6 and 201.

Once the link with cell F.b has become good enough, compared with the link with cell I.a, to meet the required threshold, a connection is established. Thereafter, no additional penalty is imposed on the establishment of a connection with cell F.a, for example, because the mobile is already in the three handover zones which cell F.a is in.

Thought must be given to the setting of the penalty values associated with the different handover zones. For example, the penalty associated with zone 201 should preferably be set high enough to prevent most mobiles on the highway 502 from connecting to cells in this zone, but must not be set so high that it prevents the establishment of good quality connections for mobiles which leave the highway and enter the town 501.

As well as penalty values as described above it is also possible to set “negative penalties” which promote handovers to particular cells, by allowing the establishment of certain radio links, even if the normal criteria are not met.

When establishment of a particular connection would involve entering two new handover zones, the penalty associated therewith can be calculated in different ways. For example, the penalty may be the higher of the two penalties associated with the two new handover zones. Alternatively, the penalty may be the sum of the two penalties associated with the two new handover zones.

As discussed above, establishment of a connection with a base station which is controlled by a different RNC from all existing connections (an inter-RNC handover) requires more additional resources than establishment of a connection with a base station to which there are no existing connections, but which is controlled by the same RNC as one or more existing connections (an intra-RNC handover). Thus, the penalty associated with an inter-RNC handover can advantageously be higher than that associated with an intra-RNC handover.

There is thus described a network, and a method of operation thereof, which allow a network operator to influence movements of a mobile station within the radio environment.

1. A mobile cellular telecommunications network employing macro-diversity,
wherein a mobile station can establish a plurality of radio links with cells in the network,
wherein the cells of the network are considered in groups,
and wherein, when determining whether to establish a new radio link between a mobile station and a new cell, the network applies a quality criterion to the new link, which depends on whether the new cell belongs to any group with which the mobile station does not already have a link.

2. A mobile cellular telecommunications network as claimed in claim 1,
wherein the network applies a more easily satisfied criterion to the establishment of a new link with a cell in one or more groups with which the mobile station already has a link, and a less easily satisfied criterion to the establishment of a new link with a cell in a group with which the mobile station currently has no link.

3. A mobile cellular telecommunications network as claimed in claim 1,
wherein the quality criterion relates to a signal quality level.

4. A mobile cellular telecommunications network as claimed in claim 1,
wherein the quality criterion relates to a longer time period for which a signal quality level is satisfied.

5. A mobile cellular telecommunications network as claimed in claim 1,
wherein a plurality of layers of groups can be defined, such that each cell may be in one group within each layer.

6. A mobile cellular telecommunications network as claimed in claim 5,
wherein cells associated with one base station are considered to be in the same group.

7. A mobile cellular telecommunications network as claimed in claim 5,
wherein cells associated with one radio network controller are considered to be in the same group.

8. A mobile cellular telecommunications network as claimed in claim 5,
wherein cells associated with a first base station are considered to be in a first group;
wherein cells associated with a second base station are considered to be in a second group;
wherein cells associated with a first radio network controller are considered to be in a third group; and
wherein cells associated with a second radio network controller are considered to be in a fourth group.

9. A mobile cellular telecommunications network as claimed in claim 8,
wherein, when determining whether to establish a new radio link between a mobile station and a new cell:
the network applies a first quality criterion to the establishment of a new link with a cell associated with a base station with which the mobile station already has a link, and associated with a radio -network controller with which the mobile station already has a link;
the network applies a second less easily satisfied criterion to the establishment of a new link with a cell associated with a base station with which the mobile station currently has no link; and
the network applies a third still less easily satisfied criterion to the establishment of a new link with a cell associated with a radio network controller with which the mobile station currently has no link.

10. A mobile cellular telecommunications network as claimed in claim 1, wherein each mobile station has an active list of cells to which it has radio links, and the criteria for establishing a new radio link are set relative to the quality of the radio links to cells on the active list.

11. A mobile cellular telecommunications network as claimed in claim 1, which uses Code Division Multiple Access.

12. A method of controlling a cellular telecommunications network using macro-diversity, wherein a mobile station can establish a plurality of radio links with cells in the network, and
wherein the cells of the network are considered in groups,
the method comprising determining whether to establish a new radio link between a mobile station and a new cell by applying a quality criterion to the new link, which depends on whether the new cell belongs to any group with which the mobile station does not already have a link.

13. A method as claimed in claim 12, comprising applying a more easily satisfied criterion to the establishment of a new link with a cell in one or more groups with which the mobile station already has a link, and a less easily satisfied criterion to the establishment of a new link with a cell in a group with which the mobile station currently has no link.

14. A method as claimed in claim 12, wherein the quality criterion relates to a signal quality level.

15. A method as claimed in claim 12, wherein the quality criterion relates to a longer time period for which a signal quality level is satisfied.

16. A method as claimed in claim 12, wherein a plurality of layers of groups can be defined, such that each cell may be in one group within each layer.

17. A method as claimed in claim 16, wherein cells associated with one base station are considered to be in the same group.

18. A method as claimed in claim 16, wherein cells associated with one radio network controller are considered to be in the same group.

19. A method as claimed in claim 16, wherein cells associated with a first base station are considered to be in a first group;
wherein cells associated with a second base station are considered to be in a second group;
wherein cells associated with a first radio network controller are considered to be in a third group; and
wherein cells associated with a second radio network controller are considered to be in a fourth group.

20. A method as claimed in claim 12, comprising, when determining whether to establish a new radio link between a mobile station and a new cell:
applying a first quality criterion to the establishment of a new link with a cell associated with a base station with which the mobile station already has a link, and associated with a radio network controller with which the mobile station already has a link;
applying a second less easily satisfied criterion to the establishment of a new link with a cell associated with a base station with which the mobile station currently has no link; and
applying a third still less easily satisfied criterion to the establishment of a new link with a cell associated with a radio network controller with which the mobile station currently has no link.

21. A method as claimed in claim 12, wherein each mobile station has an active list of cells to which it has radio links, and the criteria for establishing a new radio link are set relative to the quality of the radio links to cells on the active list.

22. A method as claimed in claim 12, wherein the network uses Code Division Multiple Access.

23. A mobile cellular telecommunications network using macro-diversity,
wherein a mobile station can establish a plurality of radio links with cells in the network, the cells with which the mobile station has established radio links being defined as an active set,
wherein the cells of the network are considered in groups,
and wherein the network determines whether to establish a new radio link between a mobile station and a new cell, by determining whether a quality value of the new radio link exceeds a threshold set at a difference level below a best cell in the active set, the size of the difference level depending on whether the new cell belongs to any group to which no member of the active set belongs.

24. A method of controlling a mobile cellular telecommunications network using macro-diversity,
wherein a mobile station can establish a plurality of radio links with cells in the network, the cells with which the mobile station has established radio links being defined as an active set, and
wherein the cells of the network are considered in groups,
the method comprising determining whether to establish a new radio link between a mobile station and a new cell, by determining whether a quality value of the new radio link exceeds a threshold set at a difference level below a best cell in the active set, the size of the difference level depending on whether the new cell belongs to any group to which no member of the active set belongs.
